(19) United States
(12) Patent Application Publication
(10) Pub. No.: US 2012/0270969 A1
(43) Pub. Date: Oct. 25, 2012

(54) Accelerator Composition

(76) Inventors: Manfred Bichler, Engelsberg (DE); Christoph Hesse, Ebersberg (DE)

(21) Appl. No.: 13/451,024

(22) Filed: Apr. 19, 2012

Related U.S. Application Data
(60) Provisional application No. 61/477,755, filed on Apr. 21, 2011.

(51) Int. Cl. C04B 16/04; C08L 33/26

(52) U.S. Cl. 524/5; 524/547

(57) ABSTRACT

Compositions containing calcium silicate hydrate and at least one (co)polymer having carboxylic acid groups and/or carboxylate groups and sulphonic acid groups and/or sulphonate groups, wherein the molar ratio of the number of carboxylic acid groups and/or carboxylate groups to the sulphonic acid groups and/or sulphonate groups is from 1/20 to 20/1. Processes for producing the aqueous and also solid compositions, their use as curing accelerators in building material mixtures containing cement, slag sand, fly ash, silica dust, metakaolin, natural pozzuolanas, calcined oil shales and/or calcium aluminate cement and their use as grinding aid in the production of cement.

This application claims the benefit of the filing date under 35 U.S.C. 119(e) from U.S. Provisional Application For Patent Ser. No. 61/477,755 filed on Apr. 21, 2011.

Provided is a composition containing calcium silicate hydrate and at least one (co)polymer having carboxylic acid groups and/or carboxylate groups and sulphonic acid groups and/or sulphonate groups, wherein the molar ratio of the number of carboxylic acid groups and/or carboxylate groups to the sulphonic acid groups and/or sulphonate groups is from 1/20 to 20/1, and processes for producing the compositions, their use as curing accelerators and as grinding aid in the production of cement. Also provided are building material mixtures which contain the compositions.

Pulverulent curing accelerators for cement-based building material mixtures which owing to their solid state are fundamentally suitable for use in dry mortar mixtures are known from the prior art. Examples of such accelerators are calcium nitrate, calcium formate, calcium chloride and lithium carbonate. A disadvantage of chloride- or nitrate-containing accelerators are their adverse effects on the corrosion resistance of, for example, steel-reinforced concrete. Owing to national standards, there are use restrictions. Efflorescence on the surface of cured building materials can, especially when calcium salts are used, likewise represent a problem (for example in the case of calcium formate).

In many applications, it is necessary to achieve even greater acceleration of setting and higher early strengths in cement-based systems, for example in mortar or concrete. However, the abovementioned types of accelerators and other commercial accelerators do not at present make it possible for a person skilled in the art to achieve this objective using relatively small added amounts of the accelerator, for example less than 0.5% by weight based on the mass of the (portland) cement used. Furthermore, a naturally undesirable loss of final strength is observed in the case of the commercial accelerators, particularly at relatively high added amounts. There is thus a great need to achieve higher early strengths in many applications, which is not possible when the accelerators, in particular pulverulent accelerators, known at present in the prior art are used.

Suspensions of calcium silicate hydrate (C—S—H) have been used recently as highly efficient accelerators in (portland) cement-containing building material mixtures such as concrete. They make it possible to achieve significantly higher early strengths (6 hours) compared to the commercial accelerators. Essentially no decrease in the final strengths (28 days) is observed here. Such suspensions are described in WO 2010026155 A1. However, it is not possible for practical reasons to formulate dry mortar mixtures which contain essentially (portland) cement as binder when using the water-containing suspensions of calcium silicate hydrate (C—S—H), since the water content of the suspensions would lead to unacceptable, at least partially premature hydration of the binder.

In the technical field of (portland) cement-containing dry mortar mixtures, there is, as for non-dry mortar applications such as concrete, a great need for suitable, in particular dry, preferably pulverulent, highly effective accelerators in order to make possible, even in dry mortar systems, a significant increase in the early strengths (after 6 hours), preferably without decreases in the final strengths (strengths after 28 days). In the concrete sector, dry or pulverulent additives are not absolutely necessary but cost advantages can be achieved by avoidance of unnecessary transport of water. Efflorescence on the surface of the cured building materials should also be prevented if possible.

Therefore, provided are accelerators which overcome the abovementioned disadvantages of the prior art. In particular, the accelerators may allow an effective increase in the early strengths, in the case of dry mortar mixtures together with good compatibility with water-sensitive binders or binders which set hydraulically in the presence of water, for example (portland) cement. In particular, the final strengths of the building material mixtures may not be adversely affected while the early strengths may be effectively increased. Also provided are highly efficient accelerator suspensions which may achieve very good early strengths after 6 hours compared to commercial accelerators without a decrease in final strengths (28 days).

Provided is a composition containing calcium silicate hydrate and at least one (co)polymer having carboxylic acid groups and/or carboxylate groups and sulphonic acid groups and/or sulphonate groups, wherein the ratio of the number of carboxylic acid groups and/or carboxylate groups to the sulphonic acid groups and/or sulphonate groups is from 1/20 to 20/1, in certain embodiments from 1/5 to 5/1, and in certain embodiments from 1/2 to 2/1, and a process for producing an aqueous calcium silicate hydrate-containing suspension which is optionally suitable as setting and curing accelerator for (portland) cement-containing binder systems by reaction of a water-soluble calcium compound with a water-soluble silicate compound in the presence of an aqueous solution containing at least one (co)polymer having carboxylic acid groups and/or carboxylate groups and sulphonic acid groups and/or sulphonate groups, wherein the ratio of the number of carboxylic acid groups and/or carboxylate groups to the sulphonic acid groups and/or sulphonate groups is from 1/20 to 20/1, in certain embodiments from 1/5 to 5/1, and in certain embodiments from 1/2 to 2/1. The present compositions may be useful as grinding aids in the production of cement.

Provided is a process for producing an aqueous calcium silicate hydrate-containing suspension which is optionally suitable as a setting and curing accelerator for (portland) cement-containing binder systems by reaction of a calcium compound, optionally a calcium salt and further optionally a water-soluble calcium salt, with a silicon dioxide-containing compound under alkaline conditions, wherein the reaction takes place in the presence of an aqueous solution of a (co)polymer having carboxylic acid groups and/or carboxylate groups and sulphonic acid groups and/or sulphonate groups, where the molar ratio of the number of carboxylic acid groups and/or carboxylate groups to the sulphonic acid groups and/or sulphonate groups is from 1/20 to 20/1, in certain embodiments from 1/5 to 5/1, and in certain embodiments from 1/2 to 2/1.

Provided is a process for producing solid, optionally pulverulent, compositions, comprising:

a) mixing of an aqueous suspension of calcium silicate hydrate which is optionally suitable as setting and curing accelerator for (portland) cement-containing binder systems with at least one (co)polymer having carboxylic acid groups and/or carboxylate groups and sulphonic acid groups and/or sulphonate groups, where the ratio of the number of carboxylic acid groups and/or carboxylate groups to the sulphonic acid groups and/or sulphonate groups is from 1/20 to 20/1, optionally from 1/5 to 5/1, further optionally from 1/2 to 2/1,

b) optionally setting of a suitable solids content of the product from step a) by dilution with water and

c) drying of the product from step a) or b), optionally at temperatures below 150° C., further optionally at temperatures of less than 100° C., further optionally at temperatures of less than 80° C. and further optionally at temperatures in the range from 15° C. to 80° C.

Also provided are methods of using the present compositions as curing accelerators in building material mixtures containing (portland) cement, slag sand, fly ash, silica dust, metakaolin, natural pozzuolanas, calcined oil shales and/or calcium aluminate cement, optionally using (portland) cement and binders based on calcium sulphate, further optionally using essentially (portland) cement as binder. The methods may comprise mixing the curing accelerators with the (portland) cement, slag sand, fly ash, silica dust, metakaolin, natural pozzuolanas, calcined oil shales and/or calcium aluminate cement, and water.

Provided are building material mixtures containing the present compositions and (portland) cement, slag sand, fly ash, silica dust, metakaolin, natural pozzuolanas, calcined oil shales and/or calcium aluminate cement, optionally (portland) cement and binders based on calcium sulphate, further optionally essentially (portland) cement as binder.

The present compositions may be present in the solid state or as aqueous suspensions. In the case of solid compositions, the compositions may be pulverulent and the particle size may be less than 1000 μm, in certain embodiments less than 700 μm. The compositions may be accelerator compositions suitable as setting and curing accelerators for (portland) cement-containing binder systems. The composition may be free of binders, in certain embodiments free of (portland) cement. The suspensions thus may be essentially stable, aqueous suspensions which do not set hydraulically without addition of binders, in certain embodiments without addition of (portland) cement. The compositions may contain at least one inorganic component and at least one organic component. The inorganic component may be a modified, preferably finely divided calcium silicate hydrate (C—S—H) which can contain foreign ions such as magnesium and aluminium. The inorganic component calcium silicate hydrate (C—S—H) may have a composition described by the following formula:

aCaO,SiO₂,bAl₂O₃,cH₂O,dX₂O,eWO,

X is an alkali metal,

W is an alkaline earth metal, in certain embodiments W is an alkaline earth metal which is different from calcium,

0.1≦a≦2 optionally 0.66≦a≦1.8

0≦b≦1 optionally 0≦b≦0.1

1≦c≦6 optionally 1≦c≦6.0

0≦d≦1 optionally 0≦d≦0.4

0≦e≦2 optionally 0≦e≦0.1.

In certain embodiments the molar ratios may be selected so that a, b and e are in the abovementioned optional ranges (0.66≦a≦1.8; 0≦b≦0.1; 0≦e≦0.1).

The calcium silicate hydrate may be present in the form of foshagite, hillebrandite, xonotlite, nekoite, clinotobermorite, 9 Å—tobermorite (riversiderite), 11 Å—tobermorite, 14 Å—tobermorite (plombierite), jennite, metajennite, calcium chondrodite, afwillite, α-C₂SH, dellaite, jaffeite, rosenhahnite, killalaite and/or suolunite, particularly preferably xonotlite, 9 Å—tobermorite (riversiderite), 11 Å—tobermorite, 14 Å—tobermorite (plombierite), jennite, metajennite, afwillite and/or jaffeite in the compositions of the invention. The molar ratio of calcium to silicon in the calcium silicate hydrate may be from 0.66 to 1.8 and in certain embodiments from 0.66 to 1.8. The molar ratio of calcium to water in the calcium silicate hydrate may be from 0.6 to 6, in certain embodiments from 0.6 to 2 and in certain embodiments from 0.8 to 2.

The organic component of the composition is at least one (co)polymer having carboxylic acid groups and/or carboxylate groups and sulphonic acid groups and/or sulphonate groups, where the ratio of the number of carboxylic acid groups and/or carboxylate groups to the sulphonic acid groups and/or sulphonate groups is from 1/20 to 20/1, in certain embodiments from 1/5 to 5/1, and in certain embodiments from 1/2 to 2/1. This means that the sum of the carboxylic acid groups and carboxylate groups is formed and the sum of the sulphonic acid groups and sulphonate groups is likewise formed and the above-defined ratio of the specified sums is formed therefrom. The formulation “and/or” here means, as generally customary, that each of the abovementioned chemical groups can be present in protonated or salt form or in mixed form. The (co)polymers according to the invention may be water-soluble, with a water solubility of greater than 10 g/l at 20° C. The (co)polymers may have a main polymer chain of carbon atoms and the carboxylic acid group or carboxylate group may be located directly on carbon atoms of the main polymer chain.

The (co)polymers may be produced by free-radical (co)polymerisation of monoethylenically unsaturated monomers having a carbon-carbon double bond. Carboxylic acid monomers may be used, such as monocarboxylic acid monomers, or monomers comprising sulphonic acid groups may be used in the production of the present (co)polymers.

The term carboxylic acid monomer, as used herein, also refers to the monomers present in salt form as carboxylate (carboxylate monomers), and the term monomers comprising sulphonic acid groups, as used herein, also refers to the monomers present in salt form as sulphonate (sulphonate monomers). These can also be present in mixed form.

Examples of suitable carboxylic acid monomers are (meth)acrylic acid, ethacrylic acid, α-chloroacrylic acid, α-cyanoacrylic acid, β-methacrylic acid (crotonic acid), α-phenylacrylic acid, β-acryloxypropionic acid, sorbic acid, α-chlorosorbic acid, 2′-methylisocrotonic acid, cinnamic acid, p-chlorocinnamic acid, β-stearyl acid, itaconic acid, citraconic acid, mesaconic acid, glutaconic acid, aconitic acid, maleic acid, fumaric acid and/or tricarboxyethylene, with (meth)acrylic acid and acrylic acid. In certain embodiments, monocarboxylic acids may be suitable. It is possible to use one or more carboxylic acid monomers. Maleic acid is less well suited in certain embodiments, when used in relatively high proportions, since, owing to the relatively high affinity for calcium ions (α-carboxyl groups), a retarding influence on the setting behaviour and the early strengths (6 hours after mixing) of hydraulically setting binder mixtures may be observed. The proportion of carboxylic acid groups derived from maleic acid may be less than 20 mol % of all carboxylic acid groups in the copolymer, in certain embodiments less than 10 mol %, and in certain embodiments maleic acid monomer may not be used.

Examples of suitable sulphonic acid monomers are one or more of the monomer species (meth)allylsulphonic acid, vinylsulphonic acid, styrenesulphonic acid, 2-acrylamido-2-methylpropanesulphonic acid, 2-methacrylamido-2-methylpropanesulphonic acid, 2-acrylamidobutanesulphonic acid, and 2-acrylamido-2,4,4-trimethylpentane sulphonic acid or in each case the salts of the acid mentioned. In certain embodiments, 2-acrylamido-2-methylpropanesulphonic acid (AMPS) and salt compounds thereof may be suitable. The cations belonging to the salt compounds of the acids are not restricted in any particular way and can preferably in each case be present as monovalent or divalent metal cations, such as sodium, potassium, calcium or magnesium ions or as ammonium ions which are derived from ammonia, primary, secondary or tertiary C₁-C₂₀-alkylamines, C₁-C₂₀-alkanolamines, C₅-C₈-cycloalkylamines and C₆-C₁₄-arylamines. The alkyl radicals can in each case be branched or unbranched. Examples of such amines are methylamine, dimethylamine, trimethylamine, ethanolamine, diethanolamine, triethanolamine, cyclohexylamine, dicyclohexylamine, phenylamine and diphenylamine. In certain embodiments, alkali metal ions and/or ammonium ions, such as the sodium ion, may be suitable.

In certain embodiments, provided are compositions in which the (co)polymers comprise structural units which comprise sulphonic acid groups and have the general formula (II), in certain embodiments in an amount of from 5 to 95 mol %, and in certain embodiments from 15 to 85 mol %,

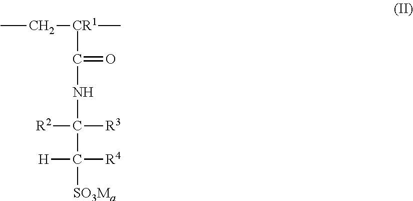

where

the radicals R¹ are identical or different and are each hydrogen or a methyl radical, R², R³, R⁴ are identical or different and are each, independently of one another, hydrogen, an aliphatic, branched or unbranched hydrocarbon radical having from 1 to 6 carbon atoms or an aromatic hydrocarbon radical having from 6 to 14 carbon atoms,

the atoms or ions M are identical or different and are each hydrogen, a monovalent or divalent metal cation or an ammonium ion,

the indices a are identical or different and are each 1/2 or 1. In the case of divalent metal cations, a is 1/2.

The (co)polymers according to the invention can be prepared by coupling the monomers forming the respective structural units by free-radical polymerisation. All monomers present as acid can be polymerized as free acids or in their salt form. Furthermore, the neutralisation of the acids can be effected by addition of appropriate bases even after the copolymerisation; partial neutralisation before or after the polymerisation is likewise possible. The neutralisation of the monomers or of the copolymers can, for example, be carried out by means of the bases sodium hydroxide, potassium hydroxide, calcium hydroxide, magnesium hydroxide and/or ammonia. Further suitable bases are primary, secondary or tertiary C₁-C₂₀-alkylamines having, in each case, branched or unbranched alkyl groups, C₁-C₂₀-alkanolamines, C₅-C₈-cycloalkylamines and/or C₆-C₁₄-arylamines. It is possible to use one or more bases. In certain embodiments, carrying out the neutralisation by means of alkali metal hydroxides and/or ammonia, such as sodium hydroxide, may be suitable. In certain embodiments, the inorganic or organic bases may be selected so that they form relatively readily water-soluble salts with the respective acid.

The (co)polymerisation may be initiated either by means of a redox initiator system or a photoinitiator. A combination of the two initiator variants is also possible. The redox initiator system comprises at least two components, viz. an organic or inorganic oxidant and an organic or inorganic reducing agent. Use may be made of compounds having peroxide units, e.g. inorganic peroxides such as alkali metal and ammonium persulphate, alkali metal and ammonium perphosphates, hydrogen peroxide and salts thereof (sodium peroxide, barium peroxide) or organic peroxides such as benzoyl peroxide, butyl hydroperoxide or peracids such as peracetic acid. However, it is also possible to use other oxidants, for example potassium permanganate, sodium and potassium chlorate, potassium dichromate, etc. As reducing agents, it is possible to use sulphur-comprising compounds such as sulphites, thiosulphates, sulphinic acid, organic thiols (for example ethyl mercaptan, 2-hydroxyethanethiol, 2-mercaptoethyl-ammonium chloride, thioglycolic acid) and others. Ascorbic acid and low-valency metal salts [copper(I); manganese(II); iron(II)] are also possible. It is also possible to use phosphorus compounds, for example sodium hypophosphite.

In the case of a photopolymerisation, this is initiated by means of UV light which brings about decomposition of a photoinitiator. As photoinitiator, it is possible to use benzoin and benzoin derivatives such as benzoin ethers, benzil and derivatives thereof, e.g. benzil ketals, acryldiazonium salts, azo initiators such as 2,2′-azobis(isobutyronitrile), 2,2′-azobis(2-amidinopropane) hydrochloride and/or acetophenone derivatives. The proportion by weight of the oxidising component and the reducing component in the case of the redox initiator systems in each case may be in the range from 0.00005 to 0.5% by weight, in certain embodiments from 0.001 to 0.1% by weight. In the case of photoinitiators, this range may be from 0.001 to 0.1% by weight, in certain embodiments from 0.002 to 0.05% by weight. The percentages by weight indicated for oxidising and reducing components and photoinitiators are in each case based on the mass of the monomers used for the copolymerisation.

The (co)polymerisation may be carried out batchwise in aqueous solution, in certain embodiments in concentrated aqueous solution, in a polymerisation vessel (batch process).

Further monomers which may be present in addition to the abovementioned carboxylic acid monomers and monomers comprising sulphonic acid groups in the (co)polymer are, for example, acrylonitrile, methacrylonitrile, vinylpyridine, isoprenol, hydroxybutyl vinyl ether, hydroxyethyl vinyl ether or alkoxylates, such as ethoxylates, of the above-mentioned ethylenically unsaturated alcohols, esters of (meth)acrylic acid with alkylpolyalkylene glycols (such as methylpolyethylene glycols (M-PEG)), styrene, vinyl acetate and/or hydroxyl-comprising (meth)acrylic esters such as hydroxyethyl(meth)acrylate and/or hydroxypropyl(meth)acrylate. The content of these further monomers may be less than 50 mol %, in certain embodiments less than 20 mol %, and in certain embodiments 0 mol %. The figures in mol % are in each case based on the sum of all monomers in the (co)polymer.

Suitable compositions are those comprising calcium silicate hydrate and at least one (co)polymer which contains carboxylic acid groups and/or carboxylate groups and sulphonic acid groups and/or sulphonate groups, where the molar ratio of the number of carboxylic acid groups and/or carboxylate groups to the sulphonic acid groups and/or sulphonate groups is from 1/20 to 20/1, wherein further polymers are present which comprise at least one polyether side chain and at least one phosphoric ester group and/or salt residue thereof. The polyether side chain may be a polyalkylene glycol, in certain embodiments a polyethylene glycol.

Suitable compositions are those comprising calcium silicate hydrate and at least one (co)polymer which contains carboxylic acid groups and/or carboxylate groups and sulphonic acid groups and/or sulphonate groups, where the molar ratio of the number of carboxylic acid groups and/or carboxylate groups to the sulphonic acid groups and/or sulphonate groups is from 1/20 to 20/1, in certain embodiments 1/5 to 5/1, and in certain embodiments 1/2 to 2/1, wherein further polymers present may be polycondensation products which comprise
(I) at least one structural unit consisting of an aromatic or heteroaromatic radical containing a polyether side chain, such as a polyalkylene glycol side chain, optionally a polyethylene glycol side chain, and
(II) at least one structural unit consisting of an aromatic or heteroaromatic radical containing at least one phosphoric ester group and/or salt thereof.

With particular preference the structural units (I) and (II) are defined by the following general formulae

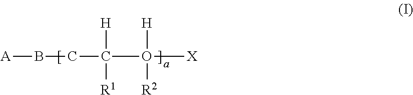

where
A is identical or different and is represented by a substituted or unsubstituted aromatic or heteroaromatic compound having 5 to 10 C atoms
where
B is identical or different and is represented by N, NH or O
where
n is 2 if B is N, and n is 1 if B is NH or O
where
R¹ and R² independently of one another are identical or different and are represented by a branched or unbranched C₁ to C₁₀ alkyl radical, C₅ to C₈ cycloalkyl radical, aryl radical, heteroaryl radical or H
where
a is identical or different and is represented by an integer from 1 to 300
where
X is identical or different and is represented by a branched or unbranched C₁ to C₁₀ alkyl radical, C₅ to C₈ cycloalkyl radical, aryl radical, heteroaryl radical or H, preferably H,

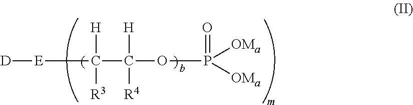

where
D is identical or different and is represented by a substituted or unsubstituted heteroaromatic compound having 5 to 10 C atoms
where
E is identical or different and is represented by N, NH or O
where
m is 2 if E is N, and m is 1, if E is NH or O
where
R³ and R⁴ independently of one another are identical or different and are represented by a branched or unbranched C₁ to C₁₀ alkyl radical, C₅ to C₈ cycloalkyl radical, aryl radical, heteroaryl radical or H
where
b is identical or different and is represented by an integer from 1 to 300
where
M independently at each occurrence is an alkali metal ion, alkaline earth metal ion, ammonium ion, organic ammonium ion and/or H, a is 1 or in the case of alkaline earth metal ions is 1/2.

The groups A and D in the general formulae (I) and (II) of the polycondensation product may be represented by phenyl, 2-hydroxyphenyl, 3-hydroxyphenyl, 4-hydroxyphenyl, 2-methoxyphenyl, 3-methoxyphenyl, 4-methoxyphenyl, naphthyl, 2-hydroxynaphthyl, 4-hydroxynaphthyl, 2-methoxynaphthyl, 4-methoxynaphthyl, in certain embodiments phenyl, where A and D may be selected independently of one another and may also consist in each case of a mixture of the stated compounds. The groups B and E are represented independently of one another, in certain embodiments by O. The radicals R¹, R², R³ and R⁴ may be selected independently of one another and may be represented by H, methyl, ethyl or phenyl, in certain embodiments by H or methyl and in certain embodiments by H.

In the general formula (I), a is represented by an integer from 1 to 300, in certain embodiments 3 to 200 and in certain embodiments 5 to 150, and b in the general formula (II) by an integer from 1 to 300, in certain embodiments 1 to 50 and in certain embodiments 1 to 10. The respective radicals, whose length is defined by a and b, respectively, may consist in this case of uniform structural groups, although it may also be useful for them to be a mixture of different structural groups. Furthermore, the radicals of the general formulae (I) or (II) may independently of one another each possess the same chain length, in which case a and b are each represented by one number. It may be useful if mixtures of different chain lengths are present in each case, so that the radicals of the structural units in the polycondensation product have different numerical values for a and, independently, for b.

The phosphatized polycondensation product frequently has a weight-average molecular weight of 5,000 g/mol to 200,000 g/mol, in certain embodiments 10,000 to 100,000 g/mol and in certain embodiments 15,000 to 55,000 g/mol.

The phosphatized polycondensation product may also be present in the form of its salts, such as, for example, the sodium, potassium, organic ammonium, ammonium and/or calcium salt, in certain embodiments the sodium and/or calcium salt.

The molar ratio of the structural units (I):(II) may be 1:10 to 10:1 and in certain embodiments may be 1:8 to 1:1.

In one embodiment, the polycondensation product may comprise a further structural unit (III), which is represented by the following formula:

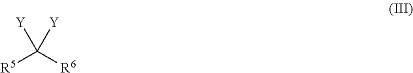

where
Y independently at each occurrence is identical or different and is represented by (I), (II) or further constituents of the polycondensation product
where
R⁵ is identical or different and is represented by H, CH₃, COOH or a substituted or unsubstituted aromatic or heteroaromatic compound having 5 to 10 C atoms, in certain embodiments H
where
R⁶ is identical or different and is represented by H, CH₃, COOH or substituted or unsubstituted aromatic or heteroaromatic compound having 5 to 10 C atoms, in certain embodiments H.

R⁵ and R⁶ in structural unit (III) are typically, independently of one another, identical or different and are represented by H, COOH and/or methyl, and in certain embodiments H.

In another embodiment the molar ratio of the structural units [(I)+(II)]:(III) in the polycondensate is 1:0.8 to 3.

Further information on the phosphatized polycondensation products and their preparation can be found in the disclosure content of WO 2011/026720 A1.

In certain embodiments, provided are compositions comprising calcium silicate hydrate, where the calcium silicate hydrate does not come from a hydration reaction of (portland) cement with water, and at least one (co)polymer which contains carboxylic acid groups and/or carboxylate groups and sulphonic acid groups and/or sulphonate groups, where the molar ratio of the number of carboxylic acid groups and/or carboxylate groups to the sulphonic acid groups and/or sulphonate groups is from 1/20 to 20/1.

In certain embodiments, provided are compositions comprising calcium silicate hydrate and at least one (co)polymer which contains carboxylic acid groups and/or carboxylate groups and sulphonic acid groups and/or sulphonate groups, where the molar ratio of the number of carboxylic acid groups and/or carboxylate groups to the sulphonic acid groups and/or sulphonate groups is from 1/20 to 20/1, the composition comprising no (portland) cement. In certain embodiments, the compositions may comprise calcium silicate hydrate and at least one (co)polymer which contains carboxylic acids groups and/or carboxylate groups and sulphonic acid groups and/or sulphonate groups, where the molar ratio of the number of carboxylic acid groups and/or carboxylate groups to the sulphonic acid groups and/or sulphonate groups is from 1/20 to 20/1, and the composition comprises no (portland) cement that has come into contact with water. By (portland) cement which has come into contact with water is meant here, additionally, mixtures of (portland) cement and water that have undergone interim drying and that may include a preferably small water component.

In certain embodiments, provided are compositions which are aqueous suspensions. In the case of aqueous suspensions, the proportion of water may be 50-99% by weight, in certain embodiments 70-99% by weight.

In a further embodiment, solid compositions are provided. These can be obtained, for example, by spray drying the suspensions. The proportion of water in the solid compositions of the invention may be less than 15% by weight, in certain embodiments less than 10% by weight. The abovementioned proportion of water can comprise both free water still present in the solid composition and water bound in the calcium silicate hydrate. The water content of the powders may be determined by drying to constant weight at 60° C. in a drying oven, with the weight difference observed being considered to be the proportion of water.

The compositions may be free of (portland) cement.

Salts, such as water-soluble salts having a solubility in water at 20° C. of greater than 1 g/l, may be present in the compositions, which may in certain embodiments be solid compositions. In certain embodiments, the salts in terms of the anionic part may be sulphates, nitrates, halides, thiocyanates, formates and/or acetates. As regards the cationic part, the salts may include alkali metals, such as sodium or potassium. Examples of suitable salts are sodium nitrate, sodium acetate, sodium formate and sodium sulphate.

In certain embodiments, provided are compositions in which the (co)polymer has a main polymer chain of carbon atoms and the ratio of the sum of the number of moles of carboxylic acid groups and/or carboxylate groups and sulphonic acid groups and/or sulphonate groups to the number of moles of carbon atoms in the main polymer chain is in the range from 0.1 to 0.6, in certain embodiments from 0.2 to 0.55. Here, the abovementioned ratio is calculated by forming the sum of the number of moles of all carboxylic acid groups, carboxylate groups, sulphonic acid groups and sulphonate groups in the (co)polymers and dividing this by the number of moles of carbon atoms in the main polymer chain. For example, a copolymer of acrylic acid and allylsulphonic acid in a molar ratio of 1/1 would give a ratio according to the above method of calculation of (1 mol of carboxylic acid+1 mol of sulphonic acid)/4 mol of carbon atoms (corresponds to 2/4). In the case of a terpolymer of acrylic acid, allylsulphonic acid and styrene in a molar ratio of 1/1/1, the ratio would be, for example, (1 mol of carboxylic acid+1 mol of sulphonic acid)/6 mol of carbon atoms (corresponds to 2/6). Any radicals which are present in the (co)polymers according to the invention and cannot be assigned to (co)monomers, for example radicals of chain termination reagents or chain initiators, are not taken into account in the calculation of the ratio indicated above. If the charge density in the (co)polymer is too low, the efficiency of the accelerators after drying may not be quite as good.

In certain embodiments, provided are compositions in which the (co)polymer may be obtained from a free-radical (co)polymerisation and the carboxylic acid groups and/or carboxylate groups are derived from monocarboxylic acid monomers, such as methacrylic acid or acrylic acid.

In certain embodiments, provided are compositions in which the (co)polymer may be obtained from a free-radical (co)polymerisation and the carboxylic acid groups and/or carboxylate groups are derived from the monomers acrylic acid and/or methacrylic acid, in certain embodiments acrylic acid, and the sulphonic acid groups and/or sulphonate groups are derived from 2-acrylamido-2-methylpropanesulphonic acid.

In certain embodiments, provided are compositions in which the weight average molecular weight M_{w} of the (co)polymer(s) is from 8,000 g/mol to 200,000 g/mol, optionally from 10,000 to 50,000 g/mol. The weight average molecular weight M_{w} is determined by means of size exclusion chromatography to determine average molar mass and conversion (column combinations: OH-Pak SB-G, OH-Pak SB 804 HQ and OH-Pak SB 802.5 HQ from Shodex, Japan; eluent: 80% by volume of an aqueous solution of HCO₂NH₄ (0.05 mol/l) and 20% by volume of acetonitrile; injection volume: 100 μl; flow rate: 0.5 ml/min). The calibration to determine the average molar mass was carried out using linear poly(ethylene oxide) and polyethylene glycol standards.

In certain embodiments, provided are compositions, such as aqueous suspensions, in which the average particle size of the calcium silicate hydrate (C—S—H) is less than 1,000 nm, in certain embodiments less than 500 nm, and in certain embodiments less than 200 nm, measured by light scattering using the Mastersizer® 2000 from Malvern.

In certain embodiments, provided are compositions in which the weight ratio of the (co)polymer or the (co)polymers to calcium silicate hydrate is from 1/100 to 4/1, optionally from 1/10 to 2/1, optionally from 1/5 to 1/1. When the amount of (co)polymer used is less than that corresponding to the abovementioned weight ratio, the stabilising action, in particular, during drying may become too weak and the efficiency as accelerator for the compositions may be less good. In certain embodiments, higher amounts of stabilizer may bring about no significant further improvement in the effectiveness of the accelerators, and the compositions may no longer be economically viable.

Provided are two processes for producing an aqueous suspension containing calcium silicate hydrate which may be suitable as setting and curing accelerator for binder systems containing (portland) cement. All production processes for producing aqueous suspensions containing calcium silicate hydrate that may be suitable as setting and curing accelerators for binder systems containing (portland) cement may be carried out in the absence of inorganic binders, in certain embodiments in the absence of (portland) cement. In this context, step a) of the process, in particular, may be carried out in the absence of inorganic binders, in certain embodiments in the absence of (portland) cement.

The aqueous suspension containing calcium silicate hydrate may be produced by reaction of a water-soluble calcium compound whose solubility in water at 20° C. may be more than 0.5 g/l, in certain embodiments more than 1.5 g/l, and in certain embodiments more than 10 g/l, with a water-soluble silicate compound whose solubility in water at 20° C. may be more than 0.01 g/l, in certain embodiments more than 1 g/l, and in certain embodiments more than 10 g/l, in the presence of an aqueous solution containing at least one (co)polymer having carboxylic acid groups and/or carboxylate groups and sulphonic acid groups and/or sulphonate groups, where the ratio of the number of carboxylic acid groups and/or carboxylate groups to the sulphonic acid groups and/or sulphonate groups is from 1/20 to 20/1, in certain embodiments from 1/5 to 5/1, and in certain embodiments from 1/2 to 2/1.

Any process which ensures that the calcium silicate hydrate is produced in the presence of the present (co)polymers may be suitable. The calcium component should, for the purposes of the present patent application, be understood as a collective term for water-soluble calcium compound and calcium compound. The silicate component should correspondingly be understood as a collective term for water-soluble silicate compound and silicon dioxide-containing compound.

Provided is a process in which a solution of the water-soluble calcium compound and a solution of the water-soluble silicate compound are added to the aqueous solution containing the (co)polymer(s) described herein. Suitable analogous processes are described in WO 2010/026155 A1, with the comb polymers described therein being replaced by the present (co)polymers. For example, the present (co)polymers may be mixed with the calcium component and then with the silicate component, or vice versa. The calcium component and silicate component can also be added to an aqueous solution of the present (co)polymers in the respective processes. The calcium component and the silicate component may be added separately to rule out any (premature) reaction of the components mentioned in the absence of the (co)polymer according to the invention.

The following ratios of amounts may be used in the present processes:

i) from 0.01 to 75% by weight, optionally from 1 to 49% by weight, further optionally from 2 to 15% by weight, of the calcium component, optionally the water-soluble calcium compound,

ii) from 0.01 to 75% by weight, optionally from 1 to 49% by weight, further optionally from 2 to 10% by weight, of the silicate component, optionally the water-soluble silicate compound,

iii) from 0.01 to 60% by weight, optionally from 0.1 to 30% by weight, further optionally from 0.1 to 10% by weight, of the (co)polymer of the invention having carboxylic acid groups and/or carboxylate groups and sulphonic acid groups and/or sulphonate groups,

iv) from 50 to 99% by weight, optionally from 70 to 99% by weight, of water.

The water-soluble calcium compound may be present as calcium chloride, calcium nitrate, calcium formate, calcium acetate, calcium bicarbonate, calcium bromide, calcium carbonate, calcium citrate, calcium chloride, calcium fluoride, calcium gluconate, calcium hydroxide, calcium hypochlorite, calcium iodate, calcium iodide, calcium lactate, calcium nitrite, calcium oxalate, calcium phosphate, calcium propionate, calcium silicate, calcium stearate, calcium sulphate, calcium sulphate hemihydrate, calcium sulphate dihydrate, calcium sulphide, calcium tartrate and/or calcium aluminate, tricalcium silicate and/or dicalcium silicate. In certain embodiments the water-soluble calcium compound may be calcium citrate, calcium tartrate, calcium formate, calcium acetate, calcium hydroxide and/or calcium sulphate, in particular calcium chloride, calcium nitrate and/or calcium sulphate. It is possible to use one or more of the water-soluble calcium compounds mentioned.

The water-soluble silicate compound may be present as sodium silicate, potassium silicate, water glass, aluminium silicate, tricalcium silicate, dicalcium silicate, calcium silicate, silica, sodium metasilicate and/or potassium metasilicate. In certain embodiments, the water-soluble silicate compound may be sodium metasilicate, potassium metasilicate and/or water glass. It is possible to use one or more of the water-soluble silicate compounds mentioned.

The process of the invention may be carried out in the absence of binders, in certain embodiments in the absence of hydraulic binders, and in certain embodiments in the absence of (portland) cement. The process products accordingly may not contain any binders, such as containing no (portland) cement.

A further process comprises producing an aqueous suspension of calcium silicate hydrate which may be suitable as setting and curing accelerator for (portland) cement-containing binder systems by reaction of a calcium compound, such as a calcium salt, such as a water-soluble calcium salt whose solubility in water at 20° C. is optionally more than 1.5 g/l, further optionally more than 10 g/l at 20° C., with a silicon dioxide-containing compound under alkaline conditions, wherein the reaction takes place in the presence of an aqueous solution of a (co)polymer having carboxylic acid groups and/or carboxylate groups and sulphonic acid groups and/or sulphonate groups, where the molar ratio of the number of carboxylic acid groups and/or carboxylate groups to the sulphonic acid groups and/or sulphonate groups is from 1/20 to 20/1, optionally from 1/5 to 5/1, further optionally from 1/2 to 2/1.

Any process which ensures that the calcium silicate hydrate is produced in the presence of the (co)polymers according to the invention may be suitable. In this context, what has been said above in respect of the processes for mixing the calcium component and the silicate component applies analogously.

The following ratios of amounts may be used in the present processes:

i) from 0.01 to 75% by weight, optionally from 1 to 49% by weight, further optionally from 2 to 15% by weight, of the calcium component, optionally a calcium compound, such as a calcium salt,

ii) from 0.01 to 75% by weight, optionally from 1 to 49% by weight, further optionally from 2 to 10% by weight, of the silicate component, optionally the silicon dioxide-containing compound,

iii) from 0.01 to 60% by weight, optionally from 0.1 to 30% by weight, further optionally from 0.1 to 10% by weight, of the (co)polymer according to the invention having carboxylic acid groups and/or carboxylate groups and sulphonic acid groups and/or sulphonate groups,

iv) from 50 to 99% by weight, optionally from 70 to 99% by weight, of water.

The calcium compound may be calcium hydroxide and/or calcium oxide. The silicon dioxide-containing compound may be selected from the group consisting of microsilica, pyrogenic silica, precipitated silica, blast furnace slag and silica sand, in particular microsilica, pyrogenic silica, precipitated silica, blast furnace slag and/or silica sand. The calcium compound may be calcium hydroxide and/or calcium oxide and the silicon dioxide-containing compound may be selected from the group consisting of microsilica, pyrogenic silica, precipitated silica, blast furnace slag and silica sand. The abovementioned types of silica are defined in Ullmann's Encyclopedia of Industrial Chemistry, Wiley-VCH, Release 2009, 7th edition, DOI 10.1002/14356007.a23_{—}583.pub3.

The process may be carried out under alkaline conditions and may have a pH of greater than 9. The molar ratio of the calcium of the calcium compound to the silicon of the silicon dioxide-containing compound may be from 0.6 to 2 and in certain embodiments from 0.66 to 1.8. The weight ratio of water to the sum of the calcium compound and the silicon dioxide-containing component in the process may be from 0.2 to 50, in certain embodiments from 2 to 10 and in certain embodiments from 4 to 6. Here, the weight ratio is that of the water used in the production process to the sum of the masses of calcium compound and silicon dioxide-containing component used.

Mechanical energy may be introduced into the reaction mixture, such as by milling, in order to activate and/or accelerate the reaction of the calcium salt with the usually less water-soluble silicon dioxide-containing components. The mechanical energy may also be advantageous for achieving the desired small particle sizes of the calcium silicate hydrates. The word “milling” as used in the present patent application refers to any process in which high shear forces are exerted on the reaction mixture in order to accelerate the reaction and obtain a suitable particle size. Milling can, for example, be carried out continuously or batchwise in a planetary ball mill or stirred ball mill. As an alternative, it is possible to use an ultradisperser, optionally at a speed of rotation of more than 5000 rpm. In addition, it is also possible to use a shaking apparatus in which small milling media, optionally having a diameter of less than 1 mm, are mixed and shaken with the reaction mixture in a container. The respective shaking apparatus can be obtained, for example, from Fast & Fluid.

The present processes may be carried out in the absence of binders, such as in the absence of hydraulic binders, such as in the absence of (portland) cement. The process products accordingly may not contain any binders.

Provided is a process for producing solid, optionally pulverulent, combinations, comprising:

a) mixing of an aqueous suspension containing calcium silicate hydrate which may be suitable as a setting and curing accelerator for (portland) cement-containing binder systems with at least one (co)polymer having carboxylic acid groups and/or carboxylate groups and sulphonic acid groups and/or sulphonate groups, where the ratio of the number of carboxylic acid groups and/or carboxylate groups to the sulphonic acid groups and/or sulphonate groups is from 1/20 to 20/1, optionally from 1/5 to 5/1, further optionally from 1/2 to 2/1,

b) optionally setting of a suitable solids content of the product from step a) by dilution with water and

c) drying of the product from step a) or b), optionally at temperatures below 150° C., further optionally at temperatures of less than 100° C., further optionally at temperatures of less than 80° C. and further optionally at temperatures in the range from 15° C. to 80° C.

Step a) of the process may be carried out, for example, by mixing a suspension of calcium silicate hydrate, such as of finely divided calcium silicate hydrate, with the present (co)polymer(s).

The calcium silicate hydrate used as starting material in step a) can firstly be produced in the form of an aqueous suspension, such as in the presence of a comb polymer plasticizer, as described in WO 2010/026155 A1. The suspensions may be produced by a process according to any of claims 1 to 15 of WO 2010/026155 A1. The content of WO 2010/026155 is incorporated by reference herein. The reaction may be a reaction of a water-soluble calcium compound with a water-soluble silicate compound in the presence of an aqueous solution containing a water-soluble comb polymer which is suitable as plasticizer for hydraulic binders. A suspension containing the calcium silicate hydrate (C—S—H) in finely divided form may be obtained. The solids content of the suspension obtained in this way may be in the range from 1 to 50% by weight, optionally from 10 to 30% by weight, further optionally from 15 to 25% by weight.

Likewise, the present aqueous suspension containing calcium silicate hydrate and (co)polymer, may be used as starting material in process step a).

The optional step b) can sometimes also be carried out using suitable organic solvents instead of water. The objective is to set a viscosity of the spray feed which is suitable for carrying out spray drying. A suitable solids content may be in the range 5-50% by weight, optionally from 15 to 25% by weight. Apart from water, it is also possible to use other solvents which do not cause any problems during spray drying and are suitable for setting an appropriate viscosity.

The drying step c) may be carried out at low temperatures and/or reduced pressure. The drying temperature selected may be less than 150° C., which may avoid dehydration of the calcium silicate hydrate particles. A convection drying oven, vacuum drying oven or fluidized-bed dryer may be suitable for drying. Spray drying may be used in order to achieve relatively high drying rates.

Without being limited by theory, the subject (co)polymers according to the invention may interact with the calcium silicate hydrate on mixing with an aqueous suspension of finely divided calcium silicate hydrate (C—S—H); in particular, an interaction between the carboxyl groups of the (co)polymer and calcium ions from the (C—S—H) may take place. Some shielding from other calcium silicate hydrate particles then presumably takes place during the drying process and agglomeration of the fine C—S—H particles during drying can thus be largely avoided. Without being limited by theory, it is assumed that the stabilising effect of the subject (co)polymers during the drying process is based on the abovementioned facts. Drying experiments (for comparison) on calcium silicate hydrate (C—S—H) without a stabilizer or with addition of materials which are not according to the present subject matter gave less effective accelerators. This is attributed to agglomeration of the calcium silicate hydrate (C—S—H) particles in the absence of the present stabilizer. Only the use of the present (co)polymers is it possible for the finely divided calcium silicate hydrate particles which are largely stable in the aqueous suspension to be stabilized in the suspension and particularly during drying so that that they can be converted into the solid state without a significant reduction in effectiveness (as accelerator). The ratio of the number of the carboxylic acid groups and/or carboxylate groups to the sulphonic acid groups and/or sulphonate groups in the subject (co)polymers may be from 1/20 to 20/1, optionally from 1/5 to 5/1, further optionally from 1/2 to 2/1. A deficiency of carboxylic acid groups may lead to the affinity of the (co)polymers for the preferably finely divided calcium silicate hydrate (C—S—H) particles not being high enough, as a result of which the effectiveness as stabilizer during drying may be insufficient and smaller accelerator effects may therefore be found in the dried products. However, polymers having a very high proportion of carboxyl groups, e.g. poly(meth)acrylic acid (no sulphonic acid and/or sulphonate groups) may have a retarding effect, presumably (but without limitation) due to an excessively high affinity for calcium.

Further embodiments of the present processes include a process step d) comprising milling of the dried products from process step c) to powders follows.

An advantage of milling to powders may be easier handling; in particular, a homogeneous distribution of the subject compositions in dry mortars may be made considerably easier.

In certain embodiments, the drying process c) may be spray drying.

Also provided is the use of the present compositions as curing accelerators in building material mixtures containing (portland) cement, slag sand, fly ash, silica dust, metakaolin, natural pozzuolanas, calcined oil shales and/or calcium aluminate cement, optionally the use of the compositions as curing accelerators in building material mixtures containing (portland) cement and binders based on calcium sulphate, further optionally containing essentially (portland) cement as binder.

In certain embodiments, the building material mixtures in which the subject compositions are used as curing accelerators may contain (portland) cement and at least one further component selected from the group consisting of slag sand, fly ash, silica dust, metakaolin, natural pozzuolanas, calcined oil shales and calcium aluminate cement. The proportion by mass of (portland) cement based on the total mass of the binders may be at least 5%, in certain embodiments at least 20%, and in certain embodiments at least 40%.

The building material mixtures containing 1.) (portland) cement and 2.) binders based on calcium sulphate are not subject to any particular restrictions in respect of the ratios of 1.) and 2.). In certain embodiments, the ratio of 1.) to 2.) may be in the range from 9/1 to 1/9, and in certain embodiments from 4/1 to 1/4.

The formulation “which contain essentially (portland) cement as binder” as used herein means that the proportion of (portland) cement is at least 40 percent by weight based on the total mass of all binders, in certain embodiments, at least 80 percent by weight, and in certain embodiments the (portland) cement represents 100% of the binder.

Also provided is the use of the present compositions as grinding aids in the production of cement, such as in the grinding of clinker or clinker blend to form cement. Processes of using the present compositions as grinding aids in the production of cement may comprise mixing the composition with clinker or clinker blend before or during grinding of the clinker or clinker blend. Clinker blend may refer to a mixture of clinker and substitutes such as slag, fly ash and/or pozzuolanas. The present compositions may be used in amounts of from 0.001% by weight to 5% by weight, in certain embodiments in amounts of from 0.01% by weight to 0.5% by weight, based in each case on the clinker or clinker blend to be ground. It is possible to use the subject compositions as grinding aids in ball mills or else in vertical mills. The subject compositions can be used as grinding aids alone or else in combination with other grinding aids, such as, for example, mono-, di-, tri- and polyglycols, polyalcohols (for example glycerol in various degrees of purity, from the production of biodiesel, for example), amino alcohols (e.g. MEA, DEA, TEA, TIPA, THEED, DIHEIPA), organic acids and/or salts thereof (e.g. acetic acid and/or salts thereof, formates, gluconates), amino acids, sugars and residues from sugar production (e.g. molasses, vinasse), inorganic salts (chlorides, fluorides, nitrates, sulphates) and/or organic polymers (e.g. polyether carboxylates (PCEs)). It has been found that the early strengths of the (portland) cement thus produced may be improved.

Also provided is the use of the subject compositions in a process for producing a sprayable composition comprising hydraulic binder, said composition comprising as essential components water, aggregates, hydraulic binder and accelerator(s), and being characterized in that the subject composition comprising calcium silicate hydrate is added before and/or at the spraying nozzle. In certain embodiments, the subject solid compositions may be employed. Further embodiments of the process for producing a hydraulically setting, sprayable hydraulic binder composition are described in international application PCT/EP2010/062671. The corresponding accelerators of this patent application, based on calcium silicate hydrate, can be used in an analogous way in the processes of PCT/EP2010/062671. The content of PCT/EP2010/062671 is incorporated by reference herein.

Also provided are building material mixtures containing the present compositions and (portland) cement, slag sand, fly ash, silicate dust, metakaolin, natural pozzuolanas, calcined oil shales and/or calcium aluminate cement; optionally building material mixtures containing the subject compositions, (portland) cement and binders based on calcium sulphate, further optionally containing essentially (portland) cement as binder. The calcium silicate hydrate present in the building material mixtures prior to the operation of mixing with make-up water may not have been formed in a hydration reaction of (portland) cement with water. Prior to the operation of mixing with make-up water, the building material mixtures may contain no (portland) cement which has come into contact with water.

The building material mixtures may contain (portland) cement and at least one further component selected from the group consisting of slag sand, fly ash, silica dust, metakaolin, natural pozzuolanas, calcined oil shales and/or calcium aluminate cement. The proportion by mass of the (portland) cement based on the total mass of the binders may be at least 5%, optionally at least 20%, further optionally at least 40%. As regards the weight ratios of 1.) (portland) cement to 2.) binders based on calcium sulphate and also the definition of “which contain essentially (portland) cement as binder”, the information given above applies analogously.

Without limitation, illustrative building material mixtures are tile adhesive formulations, renders, adhesive and reinforcing mortar, grouts, screeds and self-levelling knifing fillers. The curing accelerator composition, such as liquid curing accelerator composition, may be present in the building material mixture in an amount of from 0.5% by weight to 20% by weight, in certain embodiments from 1 to 10% by weight, based on the (portland) cement, slag sand, fly ash, silica dust, metakaolin, natural pozzuolanas, calcined oil shales and/or calcium aluminate cement. The curing accelerator composition, such as liquid curing accelerator composition, may be present in the building material mixture in an amount of from 0.5% by weight to 20% by weight, in certain embodiments from 1 to 10% by weight, based on the (portland) cement.

The present solid compositions may be used in dry mortar mixtures, such as in powder form. The solid compositions of the invention may be used in amounts of from 0.1 to 5% by weight, in certain embodiments from 0.1 to 2% by weight, based on the binder or binders, such as (portland) cement. The binders can in turn be one or more binders selected from the group consisting of (portland) cement, slag sand, fly ash, silica dust, metakaolin, natural pozzuolanas, calcined oil shales and/or calcium aluminate cement.

For the purposes of Illustration, the term building material mixtures can refer to mixtures in dry or aqueous form and in the cured or plastic state. Dry building material mixtures may, for example, be mixtures of the abovementioned binders, particularly (portland) cement, and the curing accelerator compositions (such as in powder form). Mixtures in aqueous form, generally in the form of slurries, pastes, fresh mortar or fresh concrete, are produced by addition of water to the binder component or binder components and the curing accelerator composition; they may then change over from the plastic state to the cured state.

Binders based on calcium sulphate may be gypsum, α-hemihydrate, β-hemihydrate, bassanite and/or anhydrite. The building material mixtures may contain, for example, antifoams, air pore formers, fillers, redispersible polymer powders, retarders, thickeners, water retention agents and/or wetting agents as other additives.

### EXAMPLES

### 1. Preparation of the (Co)Polymers (Polymeric Spraying Aids)

The composition of the polymeric spraying aids is summarized in Table 1.

TABLE 1
Composition of the polymeric spraying aids

| | 2-Acrylamido-2- | Acrylic | | |
|---|---|---|---|---|
| | methylpropane- | acid (AA) | | |
| | sulphonic acid | monomer | M_{w} of | |
| | (AMPS) monomer | in the | the (co)- | Solids |
| | in the (co)polymer | (co)polymer | polymers | content (% |
| Additive | (mol %) | (mol %) | (g/mol) | by weight) |
| Polymer 1 | 0 | 100 | 18 350 | 40.1 |
| (comparison) | | | | |
| Polymer 2 | 17 | 83 | 16 700 | 40.7 |
| Polymer 3 | 25 | 75 | 16 130 | 39.7 |
| Polymer 4 | 50 | 50 | 16 200 | 41.0 |
| Polymer 5 | 80 | 20 | 15 350 | 40.3 |
| Polymer 6 | 100 | 0 | 17 900 | 40.1 |
| (comparison) | | | | |

The (co)polymers used were prepared according to the following general method using the amounts of monomers indicated in Table 1:

A 5% strength Wako V50 azo initiator solution (corresponds to 0.2 mol % of azo initiator) was placed in a 1 litre four-neck flask provided with thermometer, pH meter and reflux condenser. This mixture was heated to 75° C. under a blanket of nitrogen. After 75° C. had been reached, a 40% strength, aqueous monomer mixture of 2-acrylamido-2-methylpropanesulphonic acid (AMPS) and acrylic acid (AA) (corresponding to Table 1) and 1 mol of 2-mercaptoethanol were metered in simultaneously over a period of 60 minutes. The temperature was maintained at about 80° C. by means of cooling. After the addition was complete, stirring was continued for another one hour at 80° C. This gives slightly yellowish, clear aqueous (co)polymer solutions having a solids content of from 35 to 40% by weight and a pH of from 2 to 3.5.

The weight average molecular weight M_{w} of the (co)polymers (Table 1) was determined by means of size exclusion chromatography to determine average molar mass and conversion (column combinations: OH-Pak SB-G, OH-Pak SB 804 HQ and OH-Pak SB 802.5 HQ from Shodex, Japan; eluent: 80% by volume of an aqueous solution of HCO₂NH₄ (0.05 mol/l) and 20% by volume of acetonitrile; injection volume: 100 μl; flow rate: 0.5 ml/min). The calibration to determine the average molar mass was carried out using linear poly(ethylene oxide) and polyethylene glycol standards.

### 2. Liquid Accelerator Compositions

### Examples of the Production of the Subject Liquid Compositions

### Liquid Accelerator CSH 1:

For the synthesis, the following components were weighed into a glass beaker in order and mixed briefly:

| | |
|---|---|
| Water glass Betol 39 (Woellner) | 14.3 g |
| Ca(OH)₂ (Alfa Aeser, 99%) | 4.9 g |
| Polymer 2 | 10.0 g |
| Water | 170.6 g |

The suspension was subsequently introduced into a 500 ml glass bottle containing 1 kg of yttrium-stabilized ZrO₂ balls having a diameter of 1 mm. The bottle was subsequently closed and placed in a shaker (Fast & Fluid) and shaken for 90 minutes. The resulting suspension was subsequently separated from the ZrO₂ balls and dispensed into PE bottles. The solids content of CSH 1 was 7.06% by weight. The active content of CSH 1 was 5.61% by weight. The active content was preferably defined as the solids content in percent by weight minus the proportion of organic material, in particular minus the proportion of the (co)polymers according to the invention. The solids content was preferably determined by drying the products to constant weight at a temperature of 60° C. in a drying oven.

### Liquid Accelerator CSH 2:

Accelerator 2 was produced in a manner analogous to accelerator 1, but the composition for the synthesis was as follows and a 250 ml glass flask containing 500 g of yttrium-stabilized ZrO₂ balls having a diameter of 1 mm was used:

| | |
|---|---|
| Water glass Betol 39 (Woellner) | 7.2 g |
| Ca(OH)₂ (Alfa Aeser, 99%) | 2.4 g |
| Polymer 3 | 5.0 g |
| Water | 85.4 g |

The solids content of CSH 2i was 7.68% by weight. The active content of CSH 2 was 5.36% by weight. The definitions given above in the case of CSH 1 for the active content applies.

### Tests Using the Liquid Compositions (Isothermal Heat Flow Calorimetry):

The characterisation of the resulting composition which acts as a curing accelerator was carried out by means of isothermal heat flow calorimetry using a TamAir calorimeter from TA Instruments. Here, a cement paste with and without curing accelerator was prepared and evolution of heat during curing for 22 hours at 20° C. was monitored. As cement, use was made of a Cem I 52.5 R cement.

The cement paste was produced using 20 g of cement, 6.5 g of water and 0.12 g, based on the active content, of the liquid accelerator CSH 1 or CSH 2 (corresponds to an amount of 2.14 g of CSH1 per 20 g of cement or 2.24 g of CSH2 per 20 g of cement). When the liquid accelerators compositions (CSH1 and CSH2) were added, the amount of make-up water was reduced corresponding to the amount of water introduced by the accelerators (same W/C value of 0.5 in the case of all measurements).

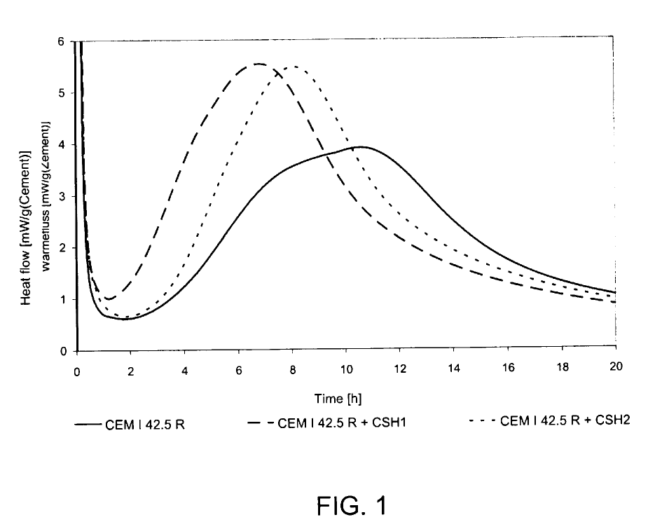

The heat flow curves for the two accelerators CSH 1 and CSH 2 according to the invention are shown in FIG. 1. The heat flow curves very clearly show the effect of the present liquid accelerator compositions on the hydration process compared to the reference without curing accelerator. The significantly more rapid, compared to the reference, hydration reaction results in higher early strengths after 6 hours.

### Tests Using the Liquid Compositions (Standard Mortar Test, 6 Hours):

The effectiveness of the subject accelerator composition was also determined by means of 6-hour compressive strengths in a standard mortar (prisms analogous to DIN EN 196-1). The results are summarized in Table 2.

### Formulation of Standard Mortar:

450 g of cement (CEM I 52.5 R)
1350 g of standard sand
225 g of water

When the liquid accelerator composition (CSH1) was added, the amount of make-up water was reduced corresponding to the amount of water introduced by the accelerator.

TABLE 2

| | Amount of accelerator | |
|---|---|---|
| | added (calculated as | |
| | active content) based | Compressive |
| | on the cement (% by | strength |
| Accelerator | weight) | after 6 h (MPa) |
| Reference (without accelerator) | — | <0.5 |
| Calcium formate, anhydrous | 0.5 | 0.5 |
| (comp.) | | |
| CaCl₂, anhydrous (comp.) | 0.5 | 3.0 |
| Ca(NO₃)₂, anhydrous (comp.) | 0.5 | 1.8 |
| CSH 1 | 0.5 * | 1.9 |

* corresponds to an added amount of 8.91% by weight of CSH1

At the same added amount based on the active content, an improved accelerator effect can be seen compared to the references calcium nitrate and calcium formate.

In this test, calcium chloride gives quite good results but it is generally undesirable or even banned according to national standards in building-chemical applications because of its chloride content which incurs a risk of corrosion. In addition, none of the accelerators based on calcium formate, calcium chloride or calcium nitrate (comparative examples in Table 2) are able to achieve good final strengths (after 28 days) similar to those obtained using the present accelerator.

### 3. Solid Accelerator Compositions

### Production of the Subject Solid Compositions (Pulverulent Accelerators):

These were produced according to the following general method:

X-Seed®-100 (BASF Construction Chemicals GmbH) was used as starting material. The suspension was mixed with 5% by weight of spraying aid (additives in Table 1) based on the solids content of X-Seed®-100 (solids content is 21.7% by weight) for 10 minutes before drying. The suspension formed was converted into the pulverulent state by spray drying using a dryer from Niro at inlet temperatures of 160° C. and outlet temperatures of 50-60° C. under a nitrogen atmosphere.

TABLE 3
Overview of the drying experiments

| Experiment | Auxiliary in spray drying | Designation of powder |
|---|---|---|
| 1 (comparison) | — | Powder 1 (comparison) |
| 2 (comparison) | Polymer 1 (comparison) | Powder 2 (comparison) |
| 3 | Polymer 2 | Powder 3 |
| 4 | Polymer 3 | Powder 4 |
| 5 | Polymer 4 | Powder 5 |
| 6 | Polymer 5 | Powder 6 |
| 7 (comparison) | Polymer 6 (comparison) | Powder 7 (comparison) |

### Tests Using the Pulverulent Compositions (Standard Mortar Test, 6 Hours):

The effectiveness of the subject accelerator composition was determined by means of 6-hour compressive strengths in a standard mortar (prisms analogous to DIN EN 196-1). To be able to compare the measurements using the various accelerators, the amount added to the mortar was in each case selected so that 1.44% by weight, based on the mass of the cement, of solid from X-Seed® 100 was added in experiments 3 and 12 to 17. This means that, of course, X-Seed® 100 is not added as such (as in comparative experiment 2) but instead a corresponding amount of solids content of the starting material X-Seed® 100 is added in the form of the pulverulent product to be processed.

### Formulation of Standard Mortar:

450 g of cement (CEM I 52.5 R)
1350 g of standard sand
225 g of water

When a liquid accelerator composition is added, the amount of the make-up water is reduced corresponding to the amount of water introduced by the accelerator.

TABLE 4
Results of the mortar tests for pulverulent accelerators

| | | | Compressive | |
|---|---|---|---|---|
| | | Accel- | strength | |
| | | erator | after 6 h | |
| Experiment | Accelerator | (g) | (MPa) | Mould |
| 1 (Comp.) | — | 0 | ~0.5 | Styropor |
| 2 (Comp.) | X-Seed ® 100 | 31.34 | 15.4 | Styropor |
| | suspension | | | |
| 3 (Comp.) | Powder 1 | 6.43 | 7.2 | Styropor |
| | (X-Seed ® 100 | | | |
| | dried without | | | |
| | additive) | | | |
| 4 (Comp.) | Ca formate (100%) | 1.13 | not | Styropor |
| | | | measurable | |
| 5 (Comp.) | Ca formate (100%) | 2.25 | 0.5 | Styropor |
| 6 (Comp.) | Ca formate (100%) | 4.50 | 2.2 | Styropor |
| 7 (Comp.) | Ca formate (100%) | 9.00 | 5.9 | Styropor |
| 8 (Comp.) | Ca(NO₃)₂•4H₂O | 1.63 | not | Styropor |
| | | | measurable | |
| 9 (Comp.) | Ca(NO₃)₂•4H₂O | 3.24 | 1.8 | Styropor |
| 10 (Comp.) | Ca(NO₃)₂•4H₂O | 6.48 | 2.2 | Styropor |
| 11 (Comp.) | Ca(NO₃)₂•4H₂O | 12.95 | 4.4 | Styropor |
| 12 (Comp.) | Powder 2 (Polymer 1) | 6.82 | 7.4 | Styropor |
| 13 | Powder 3 (Polymer 2) | 6.82 | 11.5 | Styropor |
| 14 | Powder 4 (Polymer 3) | 6.82 | 12.8 | Styropor |
| 15 | Powder 5 (Polymer 4) | 6.82 | 14.0 | Styropor |
| 16 | Powder 6 (Polymer 5) | 6.82 | 7.7 | Styropor |
| 17 (Comp.) | Powder 7 (Polymer 6) | 6.82 | 5.3 | Styropor |

It was able to be shown by means of the examples that the present compositions in liquid form (Table 2) and in dried form (Table 4) significantly increase the early strength after 6 hours in the mortar test.

In the mortar tests using pulverulent accelerators (Table 4), it was found, in particular, that even at extremely high added amounts of the comparative accelerators calcium formate and calcium nitrate it is not possible to achieve, even approximately, the high accelerator activities (early strengths) observed in the case of the present pulverulent products according to the disclosed process. The subject pulverulent products even achieve approximately the early strength of the liquid reference X-Seed®100 (suspension), which indicates only very small decreases in the accelerator activity of X-Seed®100 during drying. These effects can be attributed to the surprisingly strong stabilising action of the (co)polymers having carboxylic acid groups and/or carboxylate groups and sulphonic acid groups and/or sulphonate groups in the claimed ratios during drying.

A polyacrylic acid without sulphonic acid groups and/or sulphonate groups (comparative experiment 12), for example, does not display this effect. Conversely, a homopolymer of 2-acrylamido-2-methylpropanesulphonic acid (AMPS) is likewise not efficient (comparative example 17). In addition, none of the comparative examples in Table 4, in particular none of the comparative examples 4 to 11 (conventional accelerators based on calcium formate or calcium nitrate) are able to achieve final strengths (after 28 days) which are similarly good to those achieved using the subject pulverulent accelerators.

1. Composition containing calcium silicate hydrate and at least one (co)polymer having carboxylic acid groups and/or carboxylate groups and sulphonic acid groups and/or sulphonate groups, wherein the molar ratio of the number of carboxylic acid groups and/or carboxylate groups to the sulphonic acid groups and/or sulphonate groups is from 1/20 to 20/1.

2. Composition according to claim 1, wherein the composition is an aqueous suspension and the water content of the suspension is optionally from 50 to 99% by weight.

3. Composition according to claim 1, wherein the composition is solid.

4. Composition according to claim 1, wherein the (co)polymer has a main polymer chain of carbon atoms and the ratio of the sum of the number of carboxylic acid groups and/or carboxylate groups and sulphonic acid groups and/or sulphonate groups to the number of carbon atoms in the main polymer chain is in the range from 0.1 to 0.6.

5. Composition according to claim 1, wherein the (co)polymer is obtained from a free-radical (co)polymerisation and the carboxylic acid groups and/or carboxylate groups are derived from monocarboxylic acid monomers.

6. Composition according to claim 1, wherein the (co)polymer is obtained from a free-radical (co)polymerisation and the carboxylic acid groups and/or carboxylate groups are derived from the monomers acrylic acid and/or methacrylic acid and the sulphonic acid groups and/or sulphonate groups are derived from 2-acrylamido-2-methylpropanesulphonic acid.

7. Composition according to claim 1, wherein the weight average molecular weight M_{w} of the (co)polymer is from 8,000 g/mol to 200,000 g/mol, optionally from 10,000 to 50,000 g/mol.

8. Composition according to claim 1, wherein the weight ratio of the (co)polymer to the calcium silicate hydrate is from 1/100 to 4/1.

9. Process for producing an aqueous suspension of calcium silicate hydrate according to claim 2 which is optionally suitable as setting and curing accelerator for (portland) cement-containing binder systems by reaction of a water-soluble calcium compound whose solubility in water at 20° C. is optionally more than 0.5 g/l, with a water-soluble silicate compound whose solubility in water at 20° C. is optionally more than 0.01 g/l, in the presence of an aqueous solution containing at least one (co)polymer having carboxylic acid groups and/or carboxylate groups and sulphonic acid groups and/or sulphonate groups, where the ratio of the number of carboxylic acid groups and/or carboxylate groups to the sulphonic acid groups and/or sulphonate groups is from 1/20 to 20/1.

10. Process for producing an aqueous suspension of calcium silicate hydrate according to claim 2 which is optionally suitable as setting and curing accelerator for (portland) cement-containing binder systems by reaction of a calcium compound, optionally a calcium salt and further optionally a water-soluble calcium salt, whose solubility in water at 20° C. is optionally more than 1.5 g/l, with a silicon dioxide-containing compound under alkaline conditions, wherein the reaction takes place in the presence of an aqueous solution of a (co)polymer having carboxylic acid groups and/or carboxylate groups and sulphonic acid groups and/or sulphonate groups, wherein the molar ratio of the number of carboxylic acid groups and/or carboxylate groups to the sulphonic acid groups and/or sulphonate groups is from 1/20 to 20/1.

11. Process for producing solid, preferably pulverulent, compositions according to claim 3, comprising:
a) mixing of an aqueous suspension containing calcium silicate hydrate which is optionally suitable as setting and curing accelerator for (portland) cement-containing binder systems with at least one (co)polymer having carboxylic acid groups and/or carboxylate groups and sulphonic acid groups and/or sulphonate groups, where the ratio of the number of carboxylic acid groups and/or carboxylate groups to the sulphonic acid groups and/or sulphonate groups is from 1/20 to 20/1,
b) optionally setting of a suitable solids content of the product from step a) by dilution with water and
c) drying of the product from step a) or b), optionally at temperatures below 150° C.

12. Process according to claim 11, wherein the aqueous suspension, which contains the calcium silicate hydrate and the (co)polymer, is used as starting material in process step a) and has been obtained by reaction of a water-soluble calcium compound with a water-soluble silicate compound in the presence of an aqueous solution which contains a water-soluble comb polymer which is suitable as plasticizer for hydraulic binders.

13. Process according to claim 11, wherein the aqueous suspension, which contains the calcium silicate hydrate and the (co)polymer, is used as starting material in process step a) and has a main polymer chain of carbon atoms and the ratio of the sum of the number of carboxylic acid groups and/or carboxylate groups and sulphonic acid groups and/or sulphonate groups to the number of carbon atoms in the main polymer chain is in the range from 0.1 to 0.6.

14. Process according to claim 11, wherein the drying process c) is spray drying.

15. Process of using the composition according to claim 1 as a curing accelerator in building material mixtures containing (portland) cement, slag sand, fly ash, silica dust, metakaolin, natural pozzolanas, calcined oil shales and/or calcium aluminate cement, optionally wherein the binder is based on calcium sulphate, further optionally wherein the binder contains essentially (portland) cement, comprising mixing the curing accelerator with the (portland) cement, slag sand, fly ash, silica dust, metakaolin, natural pozzolanas, calcined oil shales and/or calcium aluminate cement, and water.

16. Process of using the composition according to claim 1 as a grinding aid in the production of cement comprising mixing the composition with clinker or clinker blend before or during grinding of the clinker or clinker blend.

17. Building material mixtures containing compositions according to claim 1 and (portland) cement, slag sand, fly ash, silica dust, metakaolin, natural pozzuolanas, calcined oil shales and/or calcium aluminate cement, optionally (portland) cement and binders based on calcium sulphate, further optionally containing essentially (portland) cement as binder.

18. Process according to claim 11, wherein the weight ratio of the (co)polymer to the calcium silicate hydrate is from 1/100 to 4/1.

19. Process according to claim 9, wherein the (co)polymer has a main polymer chain of carbon atoms and the ratio of the sum of the number of carboxylic acid groups and/or carboxylate groups and sulphonic acid groups and/or sulphonate groups to the number of carbon atoms in the main polymer chain is in the range from 0.1 to 0.6.

20. Process according to claim 10, wherein the (co)polymer has a main polymer chain of carbon atoms and the ratio of the sum of the number of carboxylic acid groups and/or carboxylate groups and sulphonic acid groups and/or sulphonate groups to the number of carbon atoms in the main polymer chain is in the range from 0.1 to 0.6.
